(19) United States
(12) Patent Application Publication
(10) Pub. No.: US 2010/0229041 A1
(43) Pub. Date: Sep. 9, 2010

(54) DEVICE AND METHOD FOR EXPEDITING FEEDBACK ON CHANGES OF CONNECTION STATUS OF MONITIORING EQUIPMENTS

(75) Inventors: Yen-Ting Chen, Shing Tien City (TW); Chek-Yee Chan, Shing Tien City (TW)

Correspondence Address: MOXA INC., P.O. BOX 108-00403, TAIPEI, 106, omitted

(73) Assignee: MOXA INC., Shing Tien City (TW)

(21) Appl. No.: 12/399,032

(22) Filed: Mar. 6, 2009

(51) Int. Cl. G06F 11/30; G06F 11/28

(52) U.S. Cl. 714/30; 714/47; 714/E11.178; 714/E11.179

(57) ABSTRACT

The present invention relates to a device and method for expediting feedback on changes of connection status of monitoring equipments, comprising a CPU, a switch module and at least an optical fiber connector, wherein the CPU contains multiple reserved pins and is connected with the switch module, while the switch module is connected with at least one optical fiber connector, which includes signal detect pins that are used to connect with the switch module. The CPU is connected through one of the reserved pins with the SD pin of the optical fiber connector, and controlled by a system software to read the bit value of the signal address of the SD pin. This allows the system software to analyze and determine if the address value of the signals received by the reserved pin is changed or not, and to take action to respond when the connection status is changed. Because signals are transported without using the switch module, it will save the time required for bus communication and synchronous processing of signals, thus expediting feedback on change of connection status.

### BACKGROUND OF THE INVENTION

1. Field of the Invention

The present invention relates to a device and method for expediting feedback on changes of connection status of monitoring equipments. More particularly, the present invention relates to a method in which a central processing unit (CPU) is connected through a reserved pin with a signal detect (SD) pin of an optical fiber connector, so that signals can be transferred without using a switch module to expedite feedback on changes of connection status of proposed equipments.

2. Description of the Prior Art

With rapid progress in communication technologies, communication networks derived from them develop very quickly, and can be divided into local area networks (LANs) and wide area network (WANs) based on their size. A LAN is a network of many computers that share common network architecture in a limited geographical area, while a WAN is a larger computer network consisting of many interconnected LANs, which may cover a country or the whole world in terms of services and connectivity.

The most commonly used and basic network architecture is Ethernet, regardless of LANs or WANs. An Ethernet network includes hubs, switches or routers and other network repeaters that rely on optical fibers or twisted-pair cables for data transporting, and a combination of network repeaters and transmission wires allows LANs, computers and other devices and equipments (for example, monitoring systems or security systems) in different areas to be connected for transfer or control of data and commands.

In network repeaters of all kinds, the physical (PHY) and media access control (MAC) layers are configured to comply with OSI (Open System Interconnection) standards, among which the PHY layer generally involves the standards for connecting ports, transfer wires, etc. in network repeaters.

As optical fiber communications have many advantages including low attenuation, broad bandwidth and electromagnetic interference (EMI) shielding, optical fibers are often selected to connect backbone networks, or in combination with redundant ring technology in use of industrial Ethernet infrastructure, so as to make use of the characteristics of optical fibers to expedite feedback on connection status. Generally for checking of connection status by equipments, however, only CPUs are used to request information on the connection status from the chip in the MAC layer by using bus interfaces (for example, inter-integrated circuit (I²C), serial peripheral interface (SPI) and PCI interface). And such requests are made in two ways: one is that CPUs learn from the chip in the MAC layer which first send requests periodically to the chip in the PHY layer via serial management bus interfaces (e.g. MDC, MDIO), and the other way is that CPUs learn about the connection status directly by making requests to the chip in the PHY layer via the chip in the MAC layer. But both ways require bus interfaces in multiple layers to be used for communication, and the connection status updates can be obtained only after related signals have been processed synchronously. As the connection status is fed back very slowly and data may be lost in the long period of connection interrupt, the two ways cannot satisfy the present need to transfer the data for industrial control in an extremely short period.

As described above, the conventional methods for checking equipments' connection status have many problems and disadvantages, which the inventor and others involved aim to eliminate very urgently.

### SUMMARY OF THE INVENTION

In view of the problems and disadvantages mentioned above, the inventor, after collecting related information and inviting assessments and reviews from various parties, relying on many years of experience in this industry and through continuous trials and corrections, has finally invented the device and method for expediting feedback on changes of connection status of monitoring equipments.

The primary purpose of the present invention is to connect the CPU through a reserved pin with the SD pin of the optical fiber, so that a system software can exercise control over the CPU access to the bit value of the SD pin signal address, and then learn about changes of the status of connection between the proposed equipment and the optical fiber connector after analyzing and judging changes in the value of the signal transmission address. Because the CPU directly reads the value in the SD pin address of the optical fiber without using the switch module, this can save the time required for bus data exchange and synchronous processing of signals inside the switch module when the signals are transported, thus expediting feedback on changes of connection status. Since changes of connection status of the proposed equipments can be handled quickly, this will help shorten the period during which data cannot be received, reduce the amount of the data to be lost and keep industrial Ethernet network systems working uninterruptedly.

The secondary purpose of the present invention is to connect the CPU through a reserved pin with the SD pin of the optical fiber, so that the CPU can have direct access to signals in the SD pin without using the switch module, which includes the MAC and PHY circuits. Because signals do not transport through the switch module, failures or errors in MAC or PHY circuits will not have impact on the system software in analyzing and judging changes of the value of the signal transmission address, thus improving the accuracy in monitoring connection status of the proposed equipments.

### DETAILED DESCRIPTION OF THE PREFERRED EMBODIMENTS

In order to achieve the objectives and functions stated above as well as the technology and framework adopted in the present invention, some examples of the preferred embodiments of the present invention are illustrated in detail with reference to the accompanying drawings to fully describe the features and functions of the present invention.

Refer to FIG. 1, which is a block diagram according to one example of the preferred embodiments of the present invention. It clearly shows that the present invention comprises a CPU 1, a switch module 2, an optical fiber connector 3, a system software 4 and a memory 5, wherein:

The CPU 1 has multiple reserved pins 11, which may be multiple general purpose input/output (GPIO) pins 111 or expansion buses 112, and the expansion buses 112 are connected with a buffer 12 with multiple connecting pins 121.

The switch module 2 is connected to the CPU 1, and includes a media access control circuit (MAC) 21 and a physical circuit (PHY) 22.

The optical fiber connector 3 contains a signal detect (SD) pin 31 that is connected with the switch module 2, and the SD pin 31 is connected with a reserved pin 11 in the CPU 1.

The system software 4 can read the address values of signals received by the reserved pin 11 in the CPU 1 and perform analysis and judgment of the values.

The memory 5 is electrically linked with the CPU 1 and includes the system software 4 inside it. And the CPU 1 can read and execute the system software 4 in the memory 5.

Refer to FIGS. 1˜2, which are a block diagram and a flow chart of the steps performed according to one example of the preferred embodiments of the present invention. These figures show clearly that the steps for executing the system software 4 include:
(100) Starting.
(101) Controlling the CPU 1 to read the value of the SD pin 31 of the optical fiber connector 3 by using the reserved pin 11.
(102) Determining if there is any change of the address value of the SD pin 31 received by the reserved pin 11. If so and leading to disconnection, proceed to step 103; and if not, proceed to step 101.
(103) Triggering an event to which responses need to be made.

As described in the previous paragraphs, the CPU 1 is connected through a reserved pin 11 with the SD pin 31 of the optical fiber connector 3, so that the system software 4 can exercise control over the CPU 1 to read the signal value of the SD pin 31. Then the system software 4 reads the address value of the signals received by the reserved pin 11 to analyze and decide if there is any change of the address value. In this way, the system software 4 will learn about the status of connection between the optical fiber connector 3 and the proposed equipments, because changes of the signal address value indicate disconnection between them, while no change means that the proposed equipments remain connected with the optical fiber connector 3. That is to say, the system software 4 will be informed of changes of the connection status very quickly and response measures will be taken (for example, informing working personnel, switching on the alarm light or suspending production lines, etc.). Since the CPU 1 reads the address value of the SD pin 31 of the optical fiber connector 3 without using the MAC 21 and PHY 22 of the switch module 2 necessarily, it will save the time required for bus data communication of MAC 21 and PHY 22 as well as for synchronous processing of signals, thus expediting feedback on changes of connection status.

Refer to FIGS. 3˜5, which are a circuit diagram and two drawings of the specifications of an output enable register and an input register of the GPIO pins respectively according to one example of the preferred embodiments of the present invention. The figures show clearly that the reserved pins 11 of the CPU 1 have 16 GPIO pins 111, so one of these 16 GPIO pins 111 can be selected to connect with the SD pin 31 of the optical fiber connector 3. The pin values are defined directly by the hardware, and 0 represents laser lights going into the optical fiber connector 3, while 1 indicates no lights going into the optical fiber connector 3. Based on these definitions, the system software 4 can define the GPIO pin 111 connected with the SD pin 31 as input, and sets the bit of the GPIO pin 111 in the output enable register address as 1 according to the specifications for the CPU 1, which means that such signals are input signals. Then the system software 4 can read the address value of the input register of the GPIO pin 111 continuously and check if there are changes of the values of the bits that correspond to the register. If changes are found in the status of connection between the optical fiber connector 3 and the proposed equipments, the system software 4 will be informed of changes in the value of the input register and take measures to respond.

The aforesaid CPU 1 may be IXP422, and the SD pin 31 of the optical fiber connector 3 is connected with the GPIO pin 111 that is numbered 15, whose output enable register address is defined as the bit 15 in 0xC8004004, and the input register address is the bit 15 in 0xC8004008. Then the system software 4 will continuously analyze and determine the value in the bit 15 of the input register address, and if the value changes from 0 to 1, it will make necessary notifications and take necessary response measures.

The aforesaid CPU 1 may be IXP422 or a CPU of another type, and the optical fiber connector 3 can be connected to the GPIO pin 111 that is numbered 1, 2, 15, 16 or any other number. If the optical fiber connector 3 is connected with a GPIO pin 111 that is numbered differently, changes should be made correspondingly in the address of the output enable register and input register, and the address can be known by referring to the specifications of the CPU. In fact, the CPU specifications only include values of the addresses that can be changed in response to changes of status of connection between the proposed equipments and the optical fiber connector 3. This is intended to achieve the function that the system software 4 can learn about the connection status of the proposed equipments based on analysis and judgment of these address values, and shall not be construed to limit the scope of the appended claims of the present invention. Therefore, it is stated clearly that all modifications and equivalent structural changes made based on the descriptions and drawings of the present invention shall be included within the scope of the appended claims of the present invention.

Refer to FIGS. 6˜8, which shows a block diagram, a circuit and specifications for addresses of an expansion bus according to another example of the preferred embodiments of the present invention respectively. As shown clearly in these figures, the reserved pin 11 of the CPU 1 may also be selected from one of expansion buses 112, and the expansion buses 112 are connected with a buffer 12, which is further linked with the SD pin 31 of the optical fiber connector 3. The buffer 12 is connected with two optical fiber connectors 3 through its connecting pins 121 (G0□SD and G1□SD), and includes 8 signals (1A1□2A4). Besides, the signals in the two connecting pins 121 are defined as in the byte whose start address is 0□57000000 in the expansion bus 112 according to the specifications, and, more exactly, in the position of the bit 1 and bit 3 respectively. Only by reading values in that address (0□57000000) continuously, the system software 4 will be aware of changes in the address values of the expansion bus 112 following analysis and judgment, when there are changes of status of connection between the optical fiber connector 3 and the proposed equipments.

The aforesaid CPU 1 may be Intel IXP422 or a CPU of another different type. Take Intel IXP422 as an example, the connecting pins 121 of the buffer 12 in the CPU 1 can be connected with at least one optical fiber connector 3, as long as it has the function that the values of the bits that correspond to the addresses of the expansion bus 112 vary with the status of connection between the proposed equipments and the optical fiber connector 3. It is stated clearly that selection of Intel IXP422 shall not be construed to limit the scope of the appended claims of the present invention, and that all modifications and equivalent structural changes made based on the descriptions and drawings of the present invention shall be included within the scope of the appended claims of the present invention.

As described in the preceding paragraphs, the device and method for expediting feedback on changes of connection status of monitoring equipments, as disclosed in the present invention, when applied practically, has the advantages as follows:

(1) The CPU 1 is connected via the reserved pin 11 with the SD pin 31 of the optical fiber connector 3. Since the system software 4 can learn about any change of status of connection between the proposed equipments and the optical fiber connector 3 by analyzing and determining changes of values of signal transmission addresses directly, signals do not rely on the switch module 2 necessarily when transported. Instead, the CPU 1 will directly read the value in the SD pin 31 of the optical fiber connector 3 by using its reserved pin 11, thus saving the time required for bus communication and synchronous processing of signals in the switch module 2 and further accelerating feedback on changes of connection status.

(2) The CPU 1 is connected via the reserved pin 11 with the SD pin 31 of the optical fiber connector 3. Since the switch module 2 is not required for signal transmission, and includes the MAC 21 and PHY 22 inside it, in case of failures or errors in the MAC 21 or PHY 22, the CPU 1 can also read the value of the SD pin 31 directly. Therefore, any problem with the MAC 21 or PHY 22 will not have impact on the system software 4 to analyze and determine changes of signal transmission addresses, thus raising accuracy in monitoring connection status of the proposed equipments.

(3) The system software 4 can quickly learn about changes of connection status of proposed equipments by detecting changes of values of the signal transmission address of the reserved pin 11, and take action to respond in case of such changes. This will facilitate quick handling and repair to restore connection with the equipments if the status of connection is changed during data transferring. As the time for not receiving data is shortened, it will not only reduce the amount of the data to be lost, but also help to keep industrial Ethernet network systems working.

Thus, the present invention mainly relates to a device and method for expediting feedback on changes of connection status of monitoring equipments, wherein the reserved pin 11 of the CPU 1 is connected to the SD pin 31 of the optical fiber connector 3. It allows the system software 4 to learn if the connection status of the proposed equipments is changed or not by analyzing and judging the address value of the signals received by the reserved pin 11, so as to expedite feedback on changes of connection status. However, the descriptions given in the aforesaid paragraphs are intended only to illustrate one example of the preferred embodiments of the present invention, and shall not be construed to limit the scope of the appended claims of the present invention. It is clearly stated that all simple modifications and equivalent structural changes made based on the descriptions and drawings of the present invention shall be included within the scope of the appended claims of the present invention.

In summary, the device and method for expediting feedback on changes of connection status of monitoring equipments as disclosed in the present invention, if implemented and operated, can really achieve its functions and purposes. Therefore, it is an invention with practical applicability, and can satisfy conditions for patentability of a utility model. While the application of patent is filed pursuant to applicable laws, your early approval of the present invention will be highly appreciated so as to guarantee benefits and rights of the inventor who works hard at this invention. For any question, please do not hesitate to inform the inventor by mail, and the inventor will try his best to cooperate with you.

### BRIEF DESCRIPTION OF THE DRAWINGS

FIG. 1 is a block diagram according to one example of the preferred embodiments of the present invention.

FIG. 2 is a flow chart of the steps performed according to one example of the preferred embodiments of the present invention.

FIG. 3 shows a circuit diagram according to one example of the preferred embodiments of the present invention.

FIG. 4 shows the specifications for an output enable register of the GPIO pins according to one example of the preferred embodiments of the present invention.

FIG. 5 shows the specifications for an input register of the GPIO pins according to one example of the preferred embodiments of the present invention.

FIG. 6 is a block diagram according to another example of the preferred embodiments of the present invention.

FIG. 7 is a circuit diagram according to another example of the preferred embodiments of the present invention.

FIG. 8 shows the specifications for addresses of an expansion bus according to one example of the preferred embodiments of the present invention.

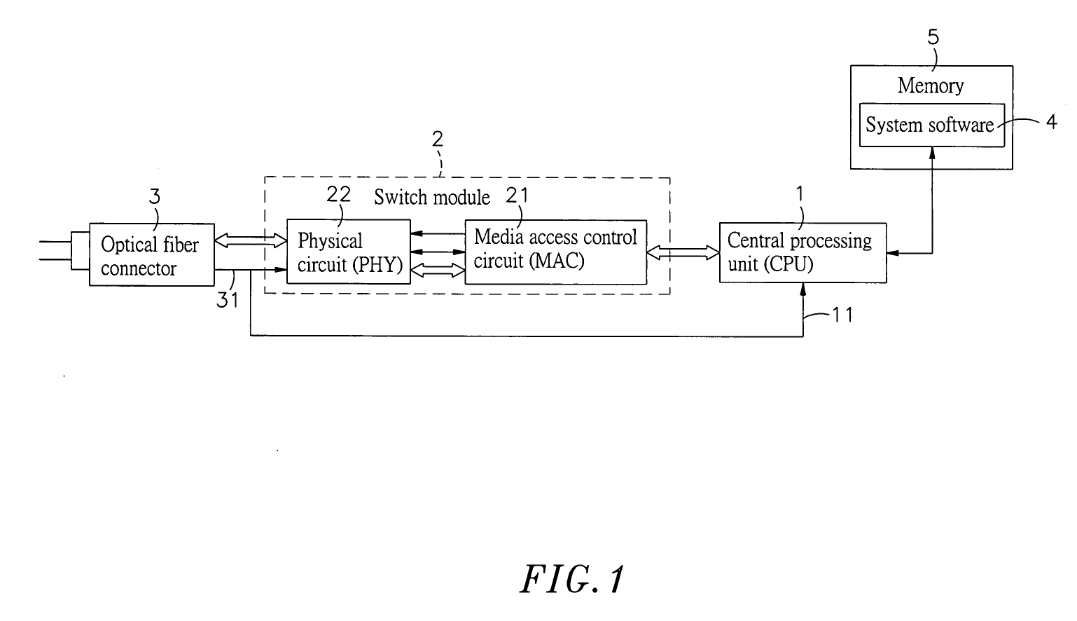

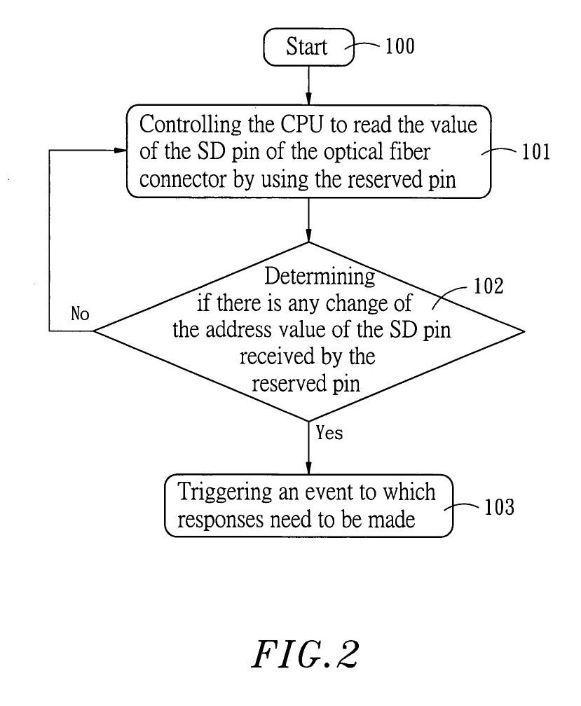

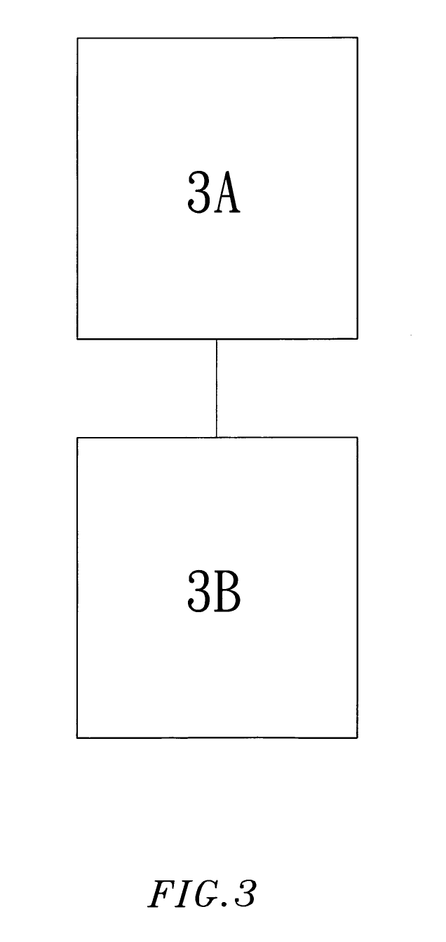

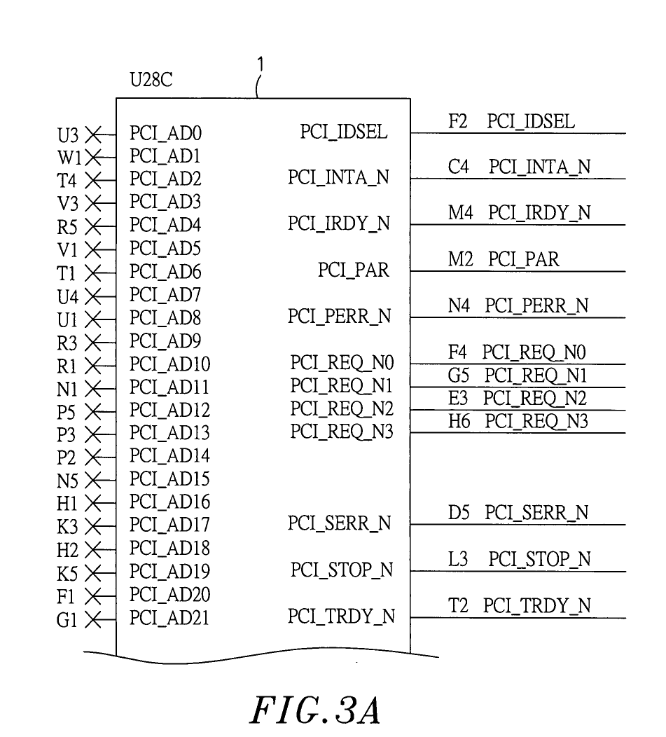

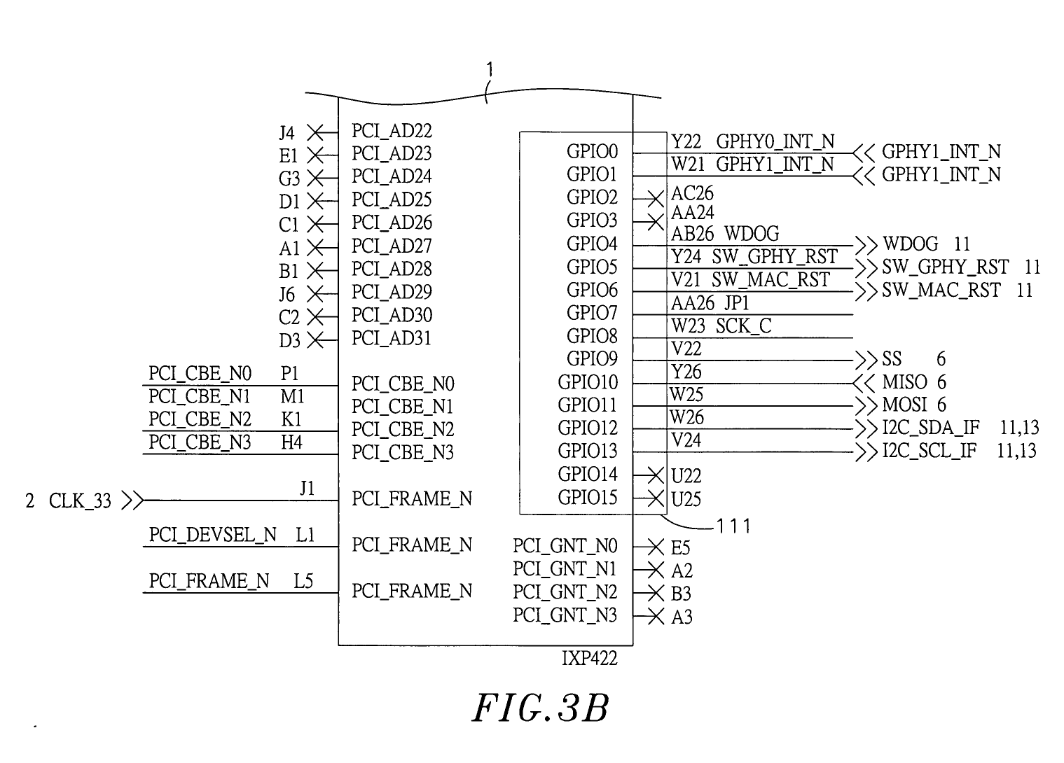

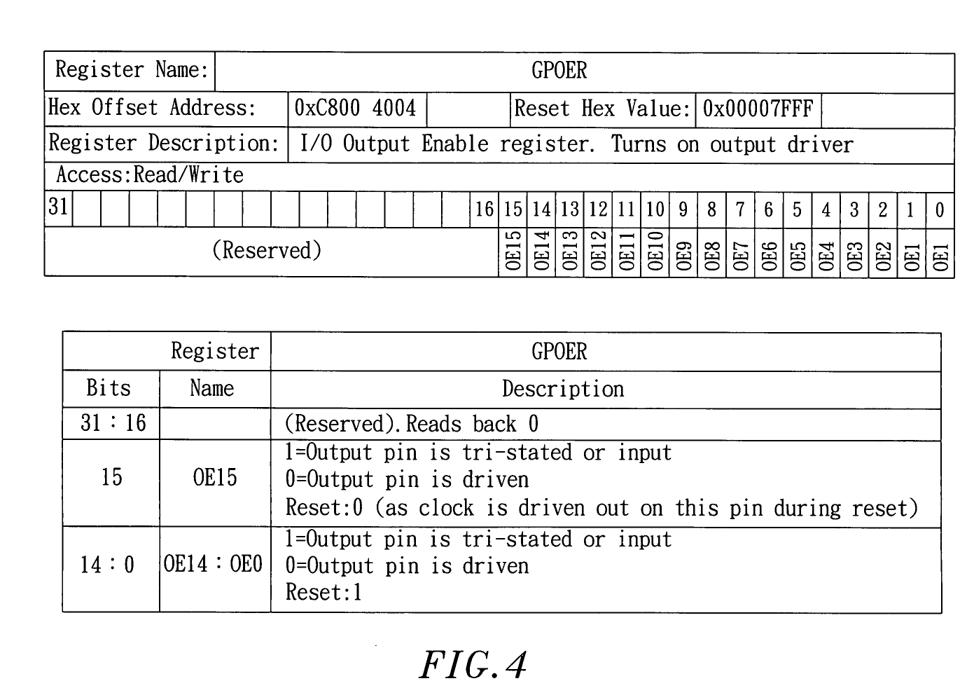

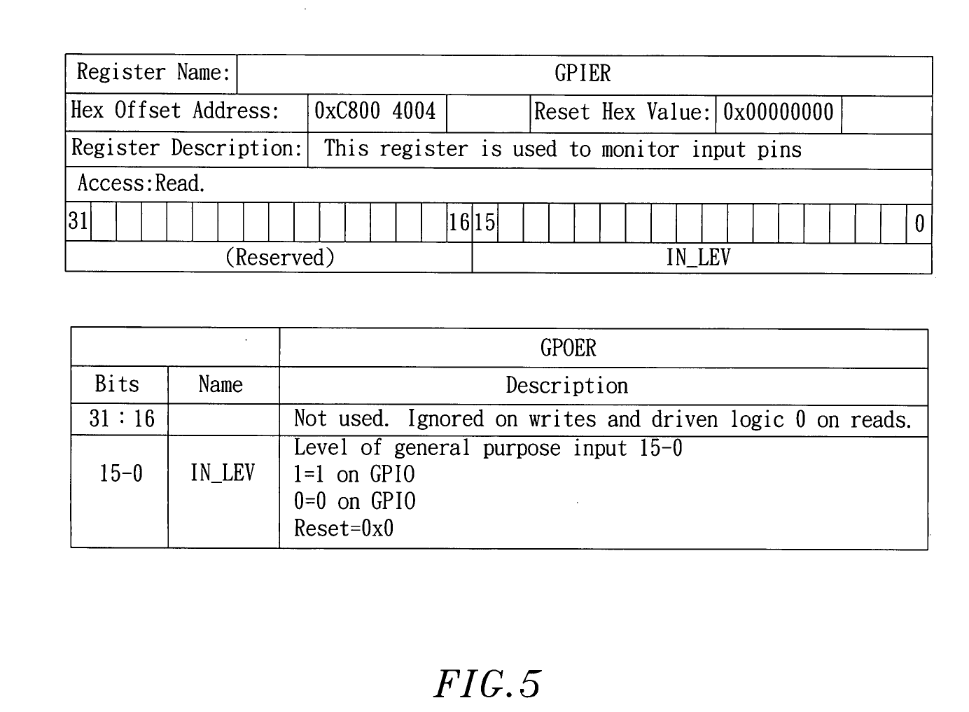

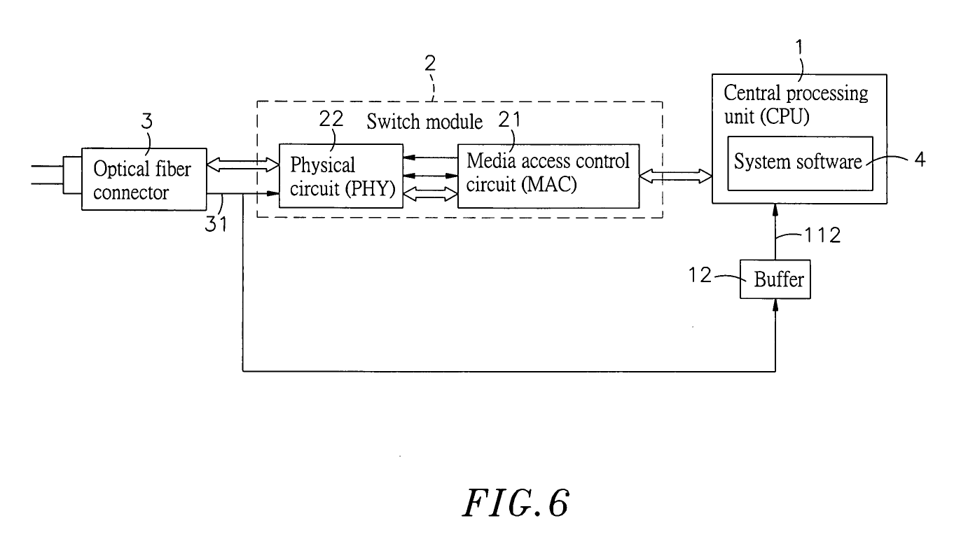

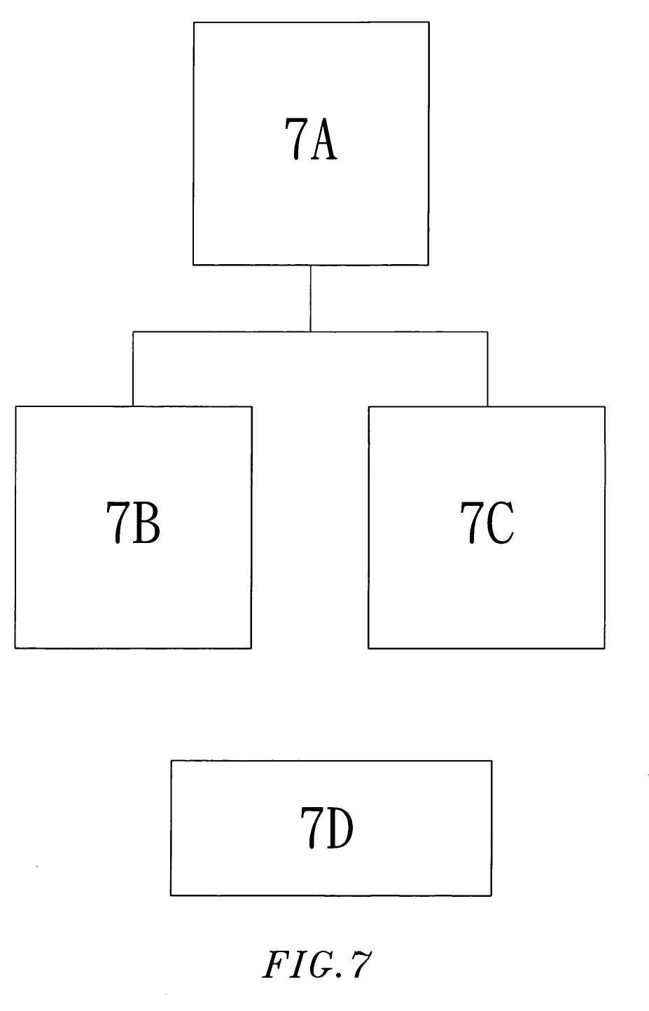

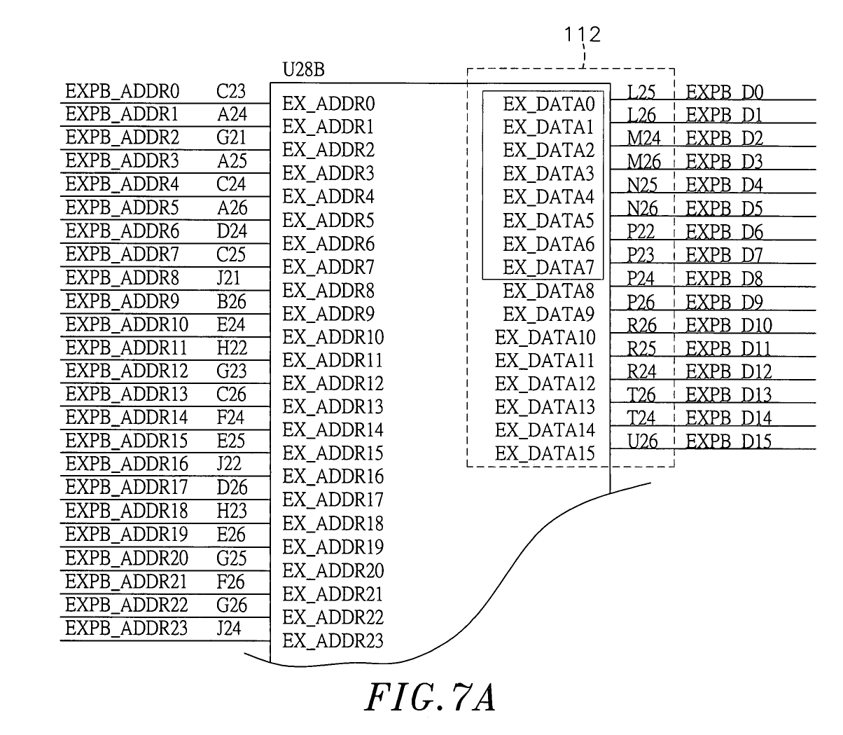

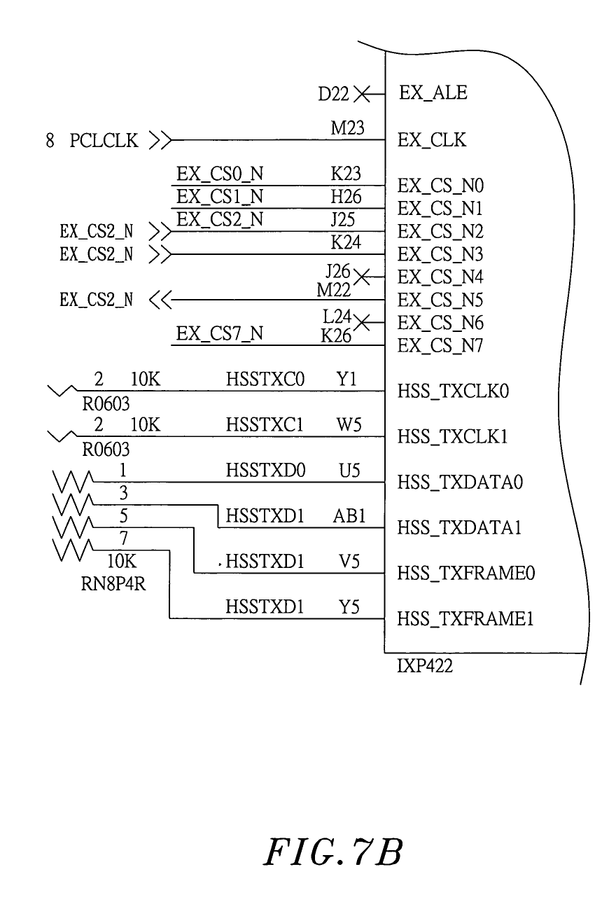

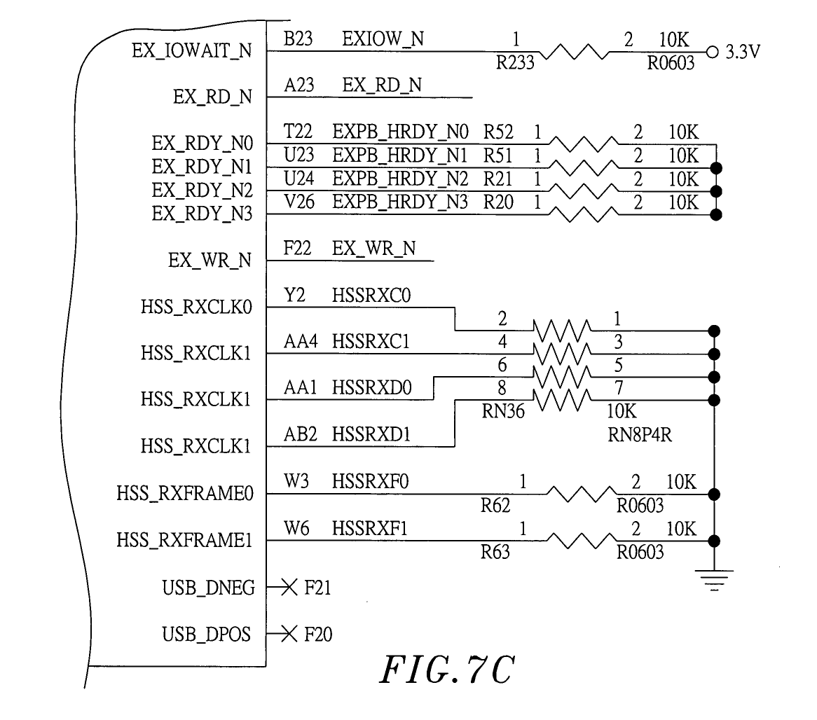

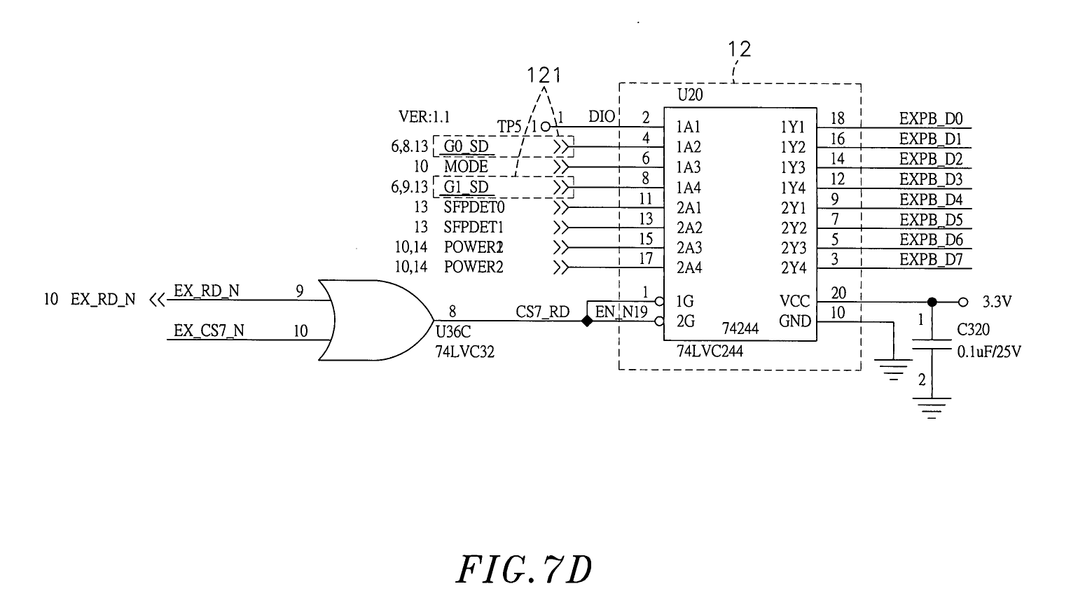

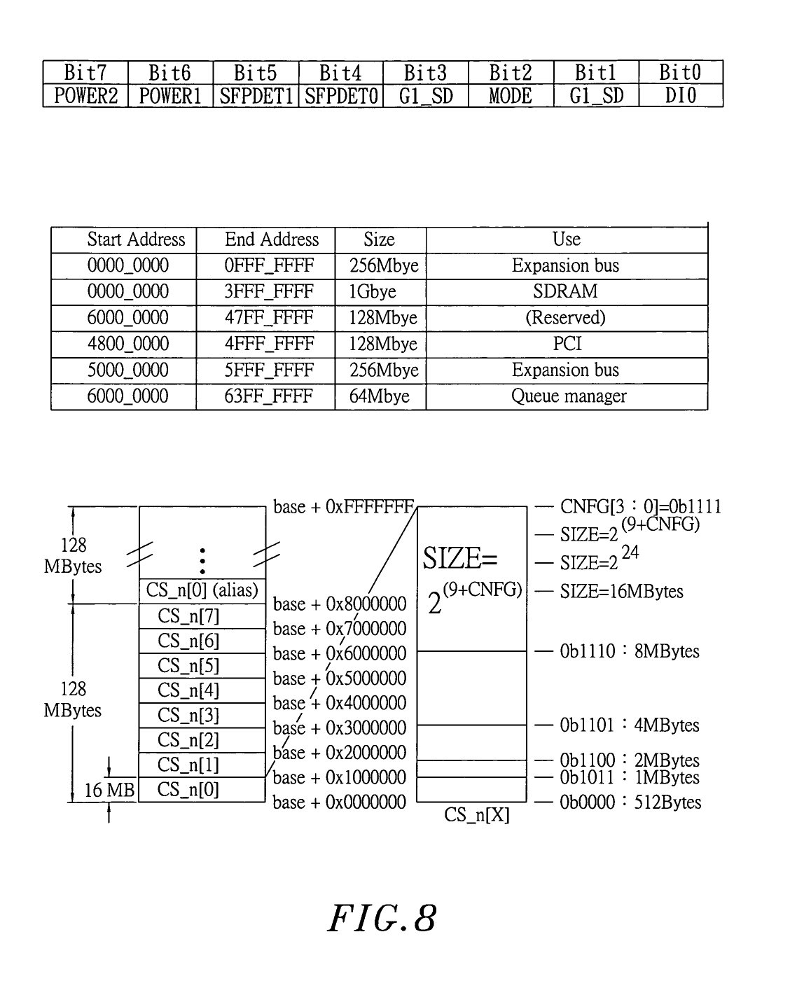

What the invention claimed is:

1. A device for expediting feedback on changes of connection status of monitoring equipments, comprising a CPU, a switch module and at least an optical fiber connector, wherein the CPU has multiple reserved pins and is connected with the switch module, while the switch module is linked with at least one optical fiber connector, which includes an SD pin that is used to connect with the switch module; The improvements include:
The CPU is connected with the SD pin of the optical fiber connector by using one of its reserved pins and is linked with a memory, inside which a system software is installed for the CPU to read and execute so as to analyze and judge if the value of the signal address received by the reserved pin is changed or not; Based on analysis and judgment of its own, the system software directly learns about the status of connection between the optical fiber connector and proposed equipments by controlling over the CPU to read the bit value of the signal address in the SD pin; In this way, change of connection status will be informed immediately and necessary measures will be taken to respond.

2. The device for expediting feedback on changes of connection status of monitoring equipments according to claim 1, wherein the reserved pins may be GPIO pins.

3. The device for expediting feedback on changes of connection status of monitoring equipments according to claim 1, wherein the reserved pins may be an expansion bus.

4. The device for expediting feedback on changes of connection status of monitoring equipments according to claim 3, wherein the expansion bus can be connected with a buffer, which includes multiple connecting pins that are used to connect with SD pins of at least one optical fiber connector.

5. A method for expediting feedback on changes of connection status of monitoring equipments, comprising a CPU, a switch module and at least an optical fiber connector, wherein the CPU has multiple reserved pins and is connected with the switch module; the switch module is linked with at least an optical fiber connector used to connect with proposed equipments, and the optical fiber connector includes SD pins that is connected with the switch module and with a reserved pin of the CPU; The CPU is connected with a memory, inside which a system software is installed for the CPU to read and execute in order to analyze and judge; The system software is used to exercise control over the CPU in reading the bit value of the signal address of the SD pin, and to determine if there is any change of the bit value; If no change is identified, it indicates that the proposed equipments are connected with the optical fiber connector, and the system software will exercise control over the CPU to read the bit value of the signal address of the SD pin; If change is identified, the proposed equipments are disconnected with the optical fiber connector, and the system software will trigger response actions.

6. The method for expediting feedback on changes of connection status of monitoring equipments according to claim 5, wherein the reserved pins may be GPIO pins, and the system software sets the bit corresponds to the addresses of the output enable register of the GPIO pins as 1; Besides, the system software will analyze and determine if the address value of the input register of the GPIO pins is changed or not.

7. The method for expediting feedback on changes of connection status of monitoring equipments according to claim 5, wherein the reserved pins may be one of expansion bus, which is connected with the SD pin of the optical fiber connector; The expansion bus is connected with a buffer, which includes multiple connecting pins that can be connected respectively with the SD pins of at least one optical fiber connector, so that the system software can learn about the connection status of the proposed equipments by analyzing and judging the bit value that corresponds to the address of the expansion bus.
